(19) United States
(12) Patent Application Publication
(10) Pub. No.: US 2005/0052746 A1
(43) Pub. Date: Mar. 10, 2005

(54) Tunable filter with a wide free spectral range

(76) Inventors: Chih-Tsung Shih, Hsinchu (TW); Hsiao-Wen Lee, Taipei (TW)

Correspondence Address: BIRCH STEWART KOLASCH & BIRCH, PO BOX 747, FALLS CHURCH, VA, 22040-0747, US

(21) Appl. No.: 10/673,388

(22) Filed: Sep. 30, 2003

(30) Foreign Application Priority Data
Sep. 10, 2003 (TW) 092125008

(51) Int. Cl. G02B 27/00

(52) U.S. Cl. 359/578; 359/577

(57) ABSTRACT

A tunable filter with a wide free spectral range is provided, having a first collimator, and a second collimator, and a mirror or Bragg reflector interposed between the first and second collimators. A resonance cavity is defined in the space between the Bragg reflector and the second collimator that is able to modulate the wavelength of a light beam passing through the filter. The variable wavelength tunable filter is able to provide better optical performance and stability and a simplified construction of the resonance cavity as compared with direct fiber couplings and traditional tunable filters.

### BACKGROUND OF THE INVENTION

1. Field of the Invention

The present invention relates to a tunable filter with wide free spectral range, in particular to an MEMS tunable filter using a resonance cavity with improved optical performance and stability, simplified construction and low costs.

2. Description of Related Arts

Dense wavelength division multiplexing (DWDM) is often used to increase the capacity of a fiber optic communication, but these DWDMs need optical filters to select signals, with specific wavelengths, passing through the optic fiber.

The conventional method of assembling the optical filter is by direct coupling of fiber cables without a resonance cavity, which has the advantage of small size, but after the addition of a non-MEMS external actuator, the size advantage is cancelled out.

Another method is to use fiber coupling with resonance cavity, as shown in FIG. 5, by using two collimators (71, 72) to create a resonance cavity (70), but the reflection loss through an optical filter without proper tilt angle cannot meet the requirements for optical signal transmission.

For those fiber couplings without a resonance cavity, the optical path can be interfered by various external factors such as changes in temperature and vibration, causing instability in optical transmission, and a drastic change in insertion loss. In FIG. 6, the two opposing lenses (73) (74) of the filter basing on direct coupling with a resonance cavity can be as either plane to plane or plane to concave. The relation between the insertion loss and the tilt angle is demonstrated in FIG. 7. If the two opposing lenses (73) (74) are plane-plane, the insertion loss is subjected to high sensitivity as the tilt angle α increases If one of the opposing lenses is concave, then the sensitivity to insertion loss decreases notably, as compared with the plane-plane configuration mentioned above.

Furthermore,, the assembling cost for this type of filter including three ferrules and two piezoelectric actuators is quite high. Even if the MEMS fabrication technique is employed for the resonance cavity using two Bragg reflectors (DBR), these two Bragg reflectors still have to be joined by chip bounding with related facilities. Because of the addition of the piezoelectric actuator, the overall size of the filter cannot be reduced and the costs cannot be lowered.

For MEMS tunable filters, the resonance cavity is formed between two distributed Bragg reflectors (DBR). The basic structure of an MEMS tunable filter using an electrostatic actuator is shown in FIG. 8, including an anti-reflection coating (AR) (81) formed over a substrate (80), a first mirror (82), a lower electrode (83), a dielectric layer (84), an upper electrode (85) and a second mirror (86) consecutively formed over the first mirror (82); and then another substrate (87) formed over the second mirror (86) to hold the second mirror (86) in a fixed position. The second mirror (86) has a concave lens surface that is opposed to the first mirror (82). A resonance cavity is formed in the space between the two mirrors (82, 86) and has an axial length of 33 um. The substrate (87) has an aperture (870) on the opposite side of the concave lens.

For modulating the wavelength of the signals passing through the optic fiber, a control voltage is applied through the upper and lower electrodes (83, 85) on the first and second mirrors (82, 86), whereby the second mirror (86) is drawn towards the first mirror (82) to close the gap between the two mirrors (82, 86).

An MEMS filter using a heat actuator is shown in FIG. 9. The basic structure includes an anti-reflection coating (91) formed on the bottom surface of a substrate (90), a first mirror (92) formed over the top of the substrate (90), and a passivation layer (93) and a second mirror (94) consecutively formed over the first mirror (92), and finally a substrate (95) to hold the second mirror (94) in a fixed position. The second mirror (94) has a concave lens as opposed to the plane lens of the first mirror (92). The two mirrors are separated by a passivation layer (93) thus creating a resonance cavity in between the mirrors. The axial length of the resonance cavity is about 40 mm, and the substrate (95) has an aperture (950) opposing the concave lens.

The above mentioned MEMS filter having the resonance cavity is able to produce better optical performance and stability, but still has the following problems:

High production costs: since the two Bragg reflectors have to be joined together by chip bounding technique, the production costs are high; and

Complicated fabrication: the resonance cavity poses a challenge for the fabrication process: the length of the resonance cavity has to be 40 um for wide frequency operating range (FSR=50 nm), but for applications requiring FSR of 400 nm, such as image spectroscopy and tunable color filters, the required length of the resonance cavity has to be 0.8 um, thus the requirement for resonance cavity calls for a sophisticated fabrication process to produce the MEMS filters.

The conventional MEMS tunable filter having resonance cavity was able to produce good optical performance and stability, but the production costs were high and the length of the resonance cavity was not easily adjustable to suit different wavelength requirements.

### SUMMARY OF THE INVENTION

The primary object of the present invention is to provide an MEMS tunable filter with simplified construction of a resonance cavity, but is able to produce high optical performance and stability with low costs.

The instrumentalities of the present invention to produce the above MEMS tunable filter include:

a first collimator;

a second collimator opposed to the first collimator; and

a mirror being interposed between the first and the second collimators with appropriate tilt angle and reflectivity, whereby a resonance cavity is defined in the space between the mirror and the second collimator.

The high reflectivity lens on the second collimator can be an MEMS lens.

The second collimator having high reflectivity lens can be adjusted to accomplish the axial length adjustment for the resonance cavity. Therefore, the wavelength of the light beams passing through the filter can be modulated by the filter.

The present construction does not require chip bounding or complicated fabrication processing, thereby the production costs can be reduced considerably as compared with the conventional techniques.

If the tunable filter uses a heat actuator to change the tilt angle of the mirror, a mirror is formed on the substrate and coated by a standard DBR process with a multi-layer membrane on the surface layer. The mirror has a properly tilted lens on the opposite side of the aperture on the substrate.

If the tunable filter uses an electrostatic actuator, a mirror is formed on the substrate and coated by a standard DBR process with a multi-layer membrane on the surface layer. The mirror has a tilted lens surface on the opposite side of the aperture on the substrate. Furthermore, the mirror has a dielectric layer and an electrode layer respectively formed on top the substrate with air pockets in the dielectric layer and the electrode layer, which are located on the opposite side of the aperture on the substrate and the concave lens on the mirror.

The multi-layer coated mirror can be formed by alternate layers of GaAs and AlAs.

The above multi-layer coated mirror can also be formed by alternate layers of TiO₂and SiO₂.

The first collimator has a lens surface with anti reflection characteristics.

The second collimator also has a lens surface with anti-reflection characteristics, such that a resonance cavity is created in the space between the reflective lens surface of the second collimator and the mirror.

The features and structure of the present invention will be more clearly understood when taken in conjunction with the accompanying drawings.

### BRIEF DESCRIPTION OF THE DRAWINGS

FIG. 1 is the basic architecture of the present invention;

FIG. 2 is one preferred embodiment of the invention;

FIG. 3 is another embodiment of the invention;

FIG. 4 is the butterfly housing for assembling the optical device;

FIG. 5 is a traditional MEMS tunable filter having a resonance cavity;

FIG. 6 is a traditional MEMS tunable filter without a resonance cavity;

FIG. 7 is a diagram demonstrating the effect of resonance cavity on the insertion loss;

FIG. 8 is a cross-sectional view of the traditional MEMS tunable filter using an electrostatic actuator; and

FIG. 9 is a cross-sectional view of the traditional MEMS tunable filter using a heat actuator.

### DETAILED DESCRIPTION OF THE PREFERRED EMBODIMENT

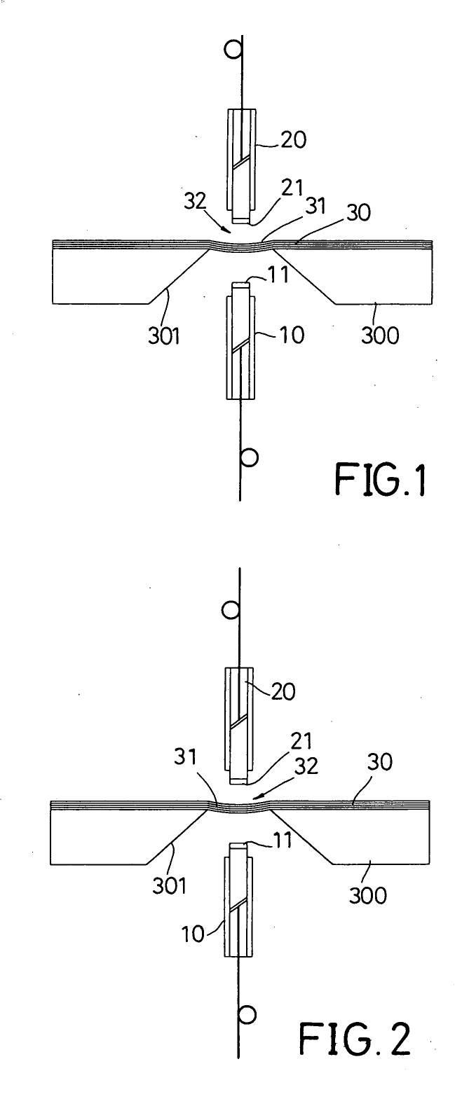

The present invention provides an MEMS filter with the basic structure as shown in FIG. 1, comprising:

a first collimator (10);

a second collimator (20) opposed to the first collimator (10) and kept apart with an appropriate distance;

a mirror (30), Bragg reflector, interposed between the first and the second collimator (10, 20) having a multi-layer polymer membrane on the lens surface, on the opposite side of an aperture (301) on a substrate (300); whereby the mirror (30) possesses an appropriate tilt angle and the lens surface (31) has a high reflection layer, and the lens surface of the first collimator (10) has an anti-reflection coating (11), and the lens surface of the second collimator (20) has a reflective layer (21), thus a Fabry-Perot resonance cavity (32) is defined in the space between the second collimator (20) and the mirror.

The reflective layer (21) of the second collimator (20) has a high reflectivity coating of Ta₂O₅ or SiO₂.

The operating principles of the present invention are to be described below. When the first collimator (10) receives a light beam, the beam passes through the concave lens surface (31 ) of the mirror (30) to reach the resonance cavity (32) formed between the concave lens surface (31) and the second collimator (20), and after producing resonance the light exits through the second collimator (20).

Since the mirror (30) having the concave lens surface (31) can be adjusted to change the distance between the mirror (30) and the second collimator (20), thereby the wavelength of the light passing through the resonance cavity (32) can be modulated. Therefore, the MEMS filter is able to suit applications requiring different wavelengths.

According to the present invention, the above mentioned resonance cavity is created with only one mirror, and the formation of the MEMS filter requires no chip bonding, thus the production costs can be effectively reduced.

Furthermore, the resonance cavity (32) is determined by the distance between the concave lens (31) of the mirror (30) and the second collimator (20), therefore by changing the position of the second collimator (20) the axial length of the resonance cavity can be easily adjusted.

The present design can avoid the problem of using dual Bragg reflectors and so eliminates the previous complicated fabrication process, but the MEMS filter is able to meet the high frequency operating range (FSR=400 nm) to suit a wide range of optic fiber applications.

In addition, the reflection loss (BR) of the filter is largely compensated by the first and second collimators (10, 20).

Since the MEMS actuator is embedded in the filter, the overall size of the filter can be reduced considerably.

The operation of the present invention is described with a preferred embodiment:

A variable wavelength filter is shown in FIG. 2 using a heat actuator. The mirror (30) is coated with a multi-layer membrane. The concave lens surface (31) of the mirror (30) possesses a tilt angle, on the opposite side of the aperture (301) of the substrate (300). The multi-layer membrane is formed by alternate layers of GaAs and AlAs.

When heat is applied on the mirror (30), the displacement of the mirror (30) changes the distance between the concave lens surface (31) of the mirror (30) and the second collimator (20).

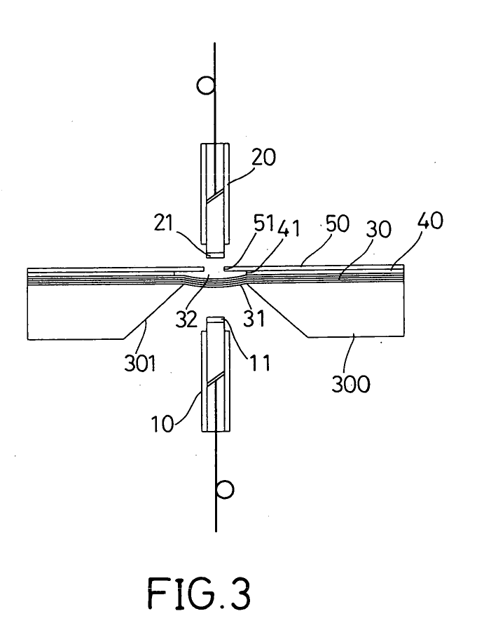

A variable wavelength MEMS filter using an electrostatic actuator is shown in FIG. 3. The mirror (30) is also coated with multi-layer membrane, on the-: opposite side of the aperture (301) on the substrate (300). The concave lens (31) of the mirror (30) corresponds to the position of the aperture (301) of the substrate (300). The mirror (30) has a dielectric layer (40) and an electrode layer (50) formed over the surface creating air pockets (41, 51) on the opposite side of the aperture (301) on the substrate (300) and the concave lens surface (31) of the mirror (30).

When a control voltage is applied on the electrode (50) and the mirror (30), the concave lens (31) closes the gap on the electrode (50), thereby the distance between the mirror and the second collimator (20) is changed, and the wavelength of the light beam passing through can be modulated.

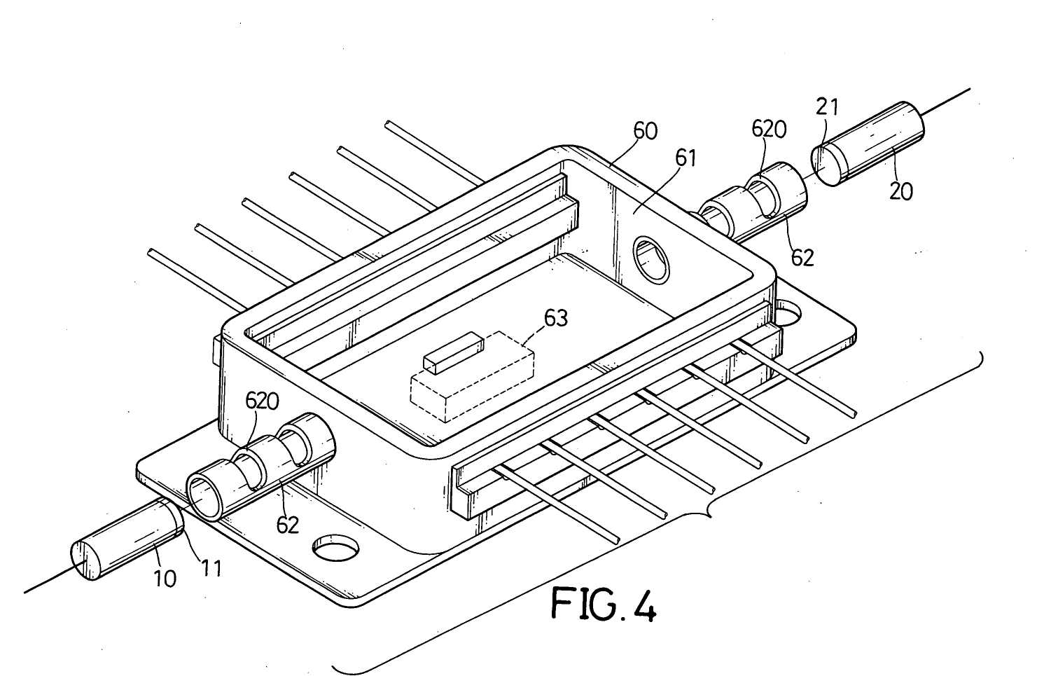

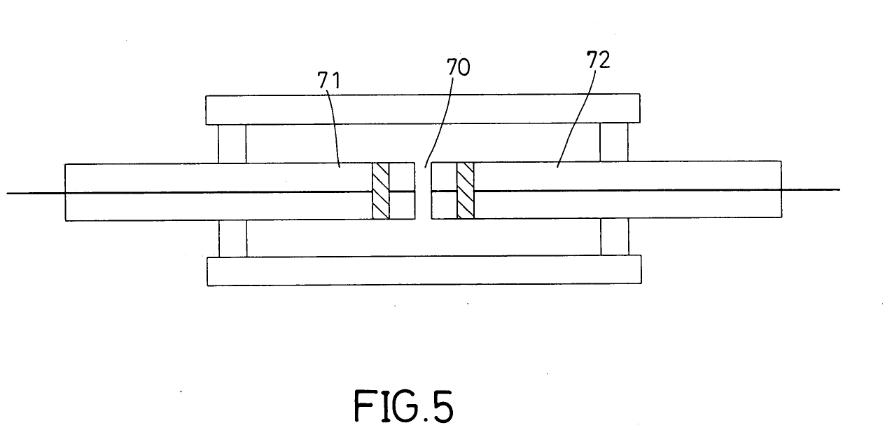

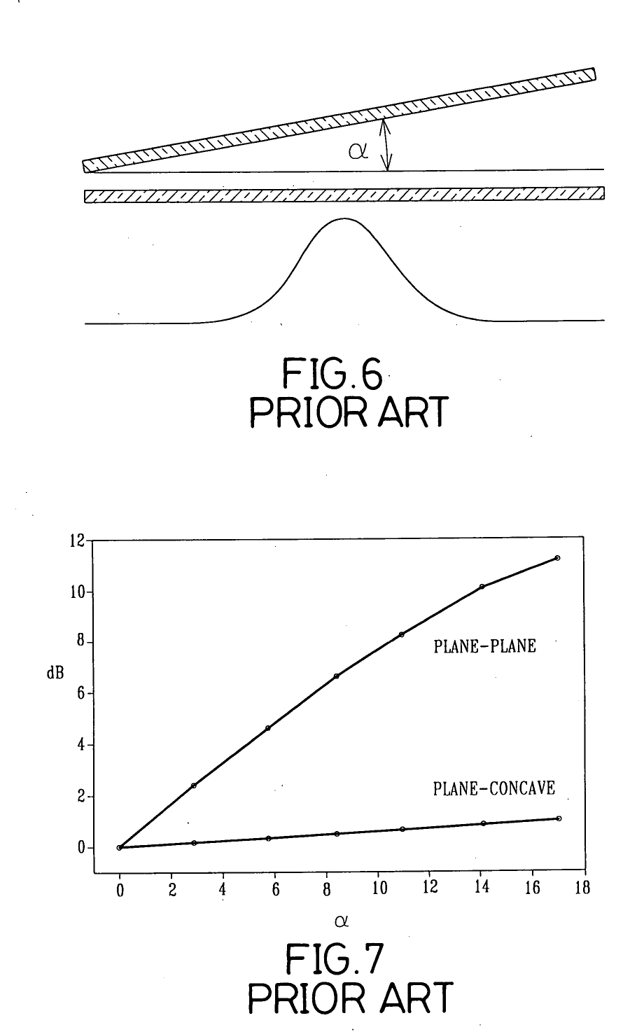

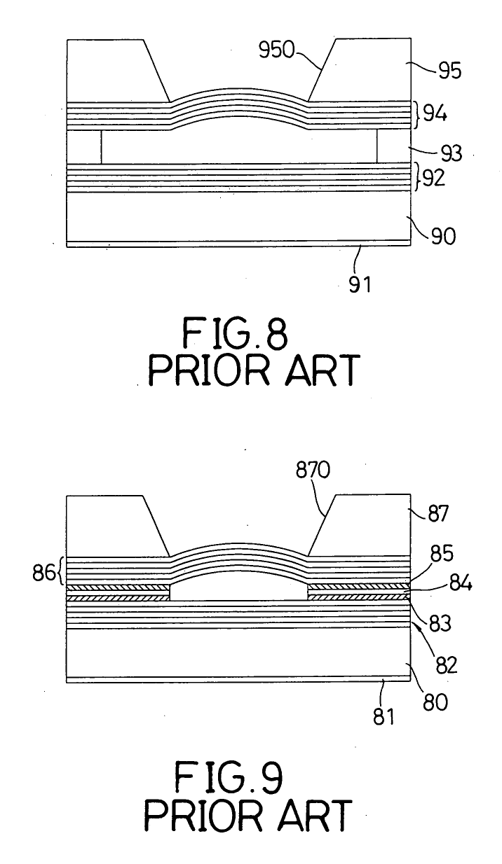

The above mirror (30) can be embedded in an MEMS chip, as shown in FIG. 4. The MEMS chip is placed at the center of a butterfly housing (60) in a chamber (61), with alignment cladding (62) on two ends of the housing (60), such that the hollow space inside the cladding (62) is connected to the chamber (61). Each cladding (62) has several notches (620) on the external wall. The first and second collimator (10) and (20) are inserted into the two claddings (62) on both ends of the butterfly housing (60) having the lenses facing inward and opposing each other. The first and second collimator (10, 20) are aligned and thereafter fixed by electroplating through the notch (620) of the cladding (62).

The MEMS chip (63) is installed in the chamber (61) by anodic bonding, in between the first and second collimator (10, 20), and then the chamber (61) is hermetically sealed off.

The present invention employs a pair of collimators and a high reflectivity Bragg reflector (DBR) to create a Fabry-Perot resonance cavity, and an electrostatic or heat actuator is used to form an MEMS tunable filter. When compared with the conventional tunable filter using two Bragg reflectors, the production costs in the present design can be effectively reduced and the fabrication process simplified. The MEMS tunable filter is able to provide better performance and stability and is smaller in size.

The foregoing description of the preferred embodiments of the present invention is intended to be illustrative only and, under no circumstances, should the scope of the present invention be so restricted.

1. A tunable filter with a wide free spectral range, comprising:
a first collimator;
a second collimator opposed to the first collimator; and
a mirror interposed between the first and second collimators, with an appropriate tilt angle and a high reflectivity lens, whereby a resonance cavity is defined in a space between the mirror and the second collimator.

2. The tunable filter as claimed in claim 1, wherein the tunable filter using a heat actuator has a mirror coated with a multi-layer membrane on a concave lens on opposite side of an aperture on a substrate; where the multi-layer membrane is formed with alternate layers of GaAs and AlAs.

3. The tunable filter as claimed in claim 1, wherein the tunable filter using an electrostatic actuator has a mirror coated with a multi-layer membrane on a concave lens surface on opposite side of an aperture on a substrate; wherein the mirror has a dielectric layer and an electrode layer formed on top of the mirror forming air pockets on opposite side of the aperture on the substrate and the concave lens surface of the mirror.

4. The tunable filter as claimed in claim 3, wherein the multi-layered membrane is formed by alternate layers of GaAs and AlAs.

5. The tunable filter as claimed in claim 3, wherein the multi-layered membrane is formed by-alternate layers of TiO₂ and SiO₂.

6. The tunable filter as claimed in claim 1, wherein the first collimator has an anti-reflection coating on the lens surface.

7. The tunable filter as claimed in claim 1, wherein the second collimator has a high reflectivity layer on the lens surface, whereby a resonance cavity is defined in the space between the concave lens of the mirror and the second collimator.

8. The tunable filter as claimed in claim 6, wherein the second collimator has a high reflectivity layer on lens surface, whereby a resonance cavity is defined in the space between the concave lens of the mirror and the second collimator.
